(19) United States
(12) Patent Application Publication
(10) Pub. No.: US 2025/0351099 A1
(43) Pub. Date: Nov. 13, 2025

(54) CONFIGURATION AND SIGNALING FOR SYNCHRONIZATION SIGNAL BLOCK TRANSMISSION

(71) Applicant: Apple Inc., Cupertino, CA (US)

(72) Inventors: Peng Cheng, Beijing (CN); Dan Wu, Beijing (CN); Haitong Sun, Saratoga, CA (US); Hong He, San Jose, CA (US); Jie Cui, San Jose, CA (US); Seung Hee Han, San Jose, CA (US)

(73) Assignee: Apple Inc., Cupertino, CA (US)

(21) Appl. No.: 19/098,893

(22) Filed: Apr. 2, 2025

Related U.S. Application Data
(60) Provisional application No. 63/645,060, filed on May 9, 2024.

(51) Int. Cl. H04W 56/00; H04W 28/06; H04W 72/231; H04W 76/20

(52) U.S. Cl. CPC H04W 56/0015; H04W 28/06; H04W 72/231; H04W 76/20

(57) ABSTRACT

The present application relates to devices and components including apparatus, systems, and methods for semi-persistent or aperiodic transmission of synchronization signal block (SSBs) on secondary cells (SCells).

### CROSS-REFERENCES TO OTHER APPLICATIONS

This application claims priority to U.S. Provisional Application No. 63/645,060, for “CONFIGURATION AND SIGNALING FOR SYNCHRONIZATION SIGNAL BLOCK TRANSMISSION” filed on May 9, 2024, which is herein incorporated by reference in its entirety for all purposes.

### TECHNICAL FIELD

This application relates generally to communication networks and, in particular, to semi-persistent or aperiodic transmission of synchronization signal blocks (SSBs).

### BACKGROUND

Wireless mobile communication technology uses various standards and protocols to transmit data between a base station and a wireless communication device. Wireless communication system standards and protocols can include, but are not limited to, the 3rd Generation Partnership Project (3GPP) long-term evolution (LTE); 5^{th} Generation (5G) 3GPP New Radio (NR); and technologies beyond 5G. In 5G wireless radio access networks (RANs), the base station may include an RAN node such as a 5G node, NR node, or next-generation node B (gNB), which communicates with a wireless communication device, also known as user equipment (UE).

### BRIEF DESCRIPTION OF THE DRAWINGS

FIG. 1 illustrates a network environment in accordance with some embodiments.

FIG. 2 illustrates a transmission diagram in accordance with some embodiments.

FIG. 3 illustrates a transmission diagram in accordance with some embodiments.

FIG. 4 illustrates a transmission diagram in accordance with some embodiments.

FIG. 5 illustrates control information in accordance with some embodiments.

FIG. 6 illustrates a downlink control information (DCI) in accordance with some embodiments.

FIG. 7 illustrates another DCI in accordance with some embodiments.

FIG. 8 illustrates an operation flow/algorithmic structure in accordance with some embodiments.

FIG. 9 illustrates an operation flow/algorithmic structure in accordance with some embodiments.

FIG. 10 illustrates a user equipment in accordance with some embodiments.

FIG. 11 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and techniques to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry,” as used herein, refers to, is part of, or includes hardware components that are configured to provide the described functionality. The hardware components may include an electronic circuit, a logic circuit, a processor (shared, dedicated, or group) or memory (shared, dedicated, or group), an application-specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry,” as used herein, refers to, is part of, or includes circuitry capable of sequentially and automatically carrying out a sequence of arithmetic or logical operations, recording, storing, or transferring digital data. The term “processor circuitry” may refer to an application processor, baseband processor, central processing unit (CPU), graphics processing unit, single-core processor, dual-core processor, triple-core processor, quad-core processor, or any other device capable of executing or otherwise operating computer-executable instructions, such as program code, software modules, or functional processes.

The term “interface circuitry,” as used herein, refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any transmission medium, either tangible or intangible, that is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, or a virtualized network function.

The term “information element” refers to a structural element containing one or more fields. The term “field” refers to individual contents of an information element or a data element that contains content. An information element may include one or more additional information elements.

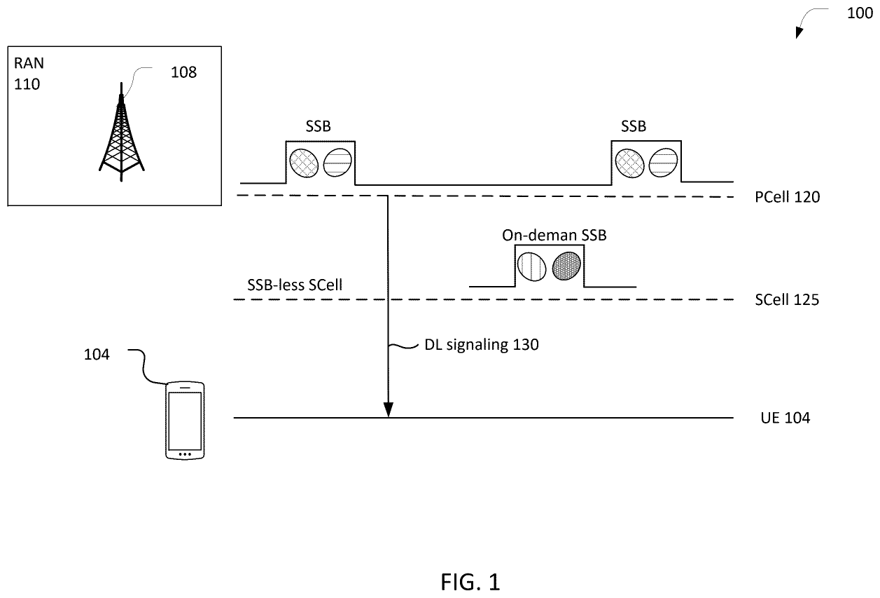

FIG. 1 illustrates a network environment 100 in accordance with some embodiments. The network environment 100 may include a UE 104 coupled with a base station (BS) 108 of a radio access network (RAN) 110 that provides one or more serving cells. In some embodiments, the BS 108 is a gNB that provides one or more 3GPP NR cells. The air interface over which the UE 104 and the BS 108 communicate may be compatible with 3GPP technical specifications (TSs), such as those that define 5G NR or later system standards (e.g., Sixth Generation (6G) standards). While the RAN 110 is shown with one base station, base station 108, it will be understood that the RAN 110 may include a number of base stations or other access nodes that provide services to various UEs through serving cells.

The initial cell with which the UE 104 establishes its connection during the initial connection establishment procedure may be referred to as primary cell (PCell) 120. A secondary cell (SCell) 125 may be a cell in addition to the PCell 120 that can be configured after the initial connection is established. In carrier aggregation scenarios, SCell 125 is aggregated with the PCell 120 to increase overall bandwidth and improve data rates.

The base station 108 may transmit several reference signals. One such signal may be the primary synchronization signal (PSS). The UE 104 may obtain the cell identity from the PSS. Another reference signal may be a secondary synchronization signal (SSS). The UE 104 may obtain frame timing from SSS. Once the UE 104 is synchronized with the cell, the UE 104 may receive system information, including master information block (MIB) and system information blocks (SIBs). The base station 108 may transmit MIB and SIBs on a physical broadcast channel (PBCH). The collection of PSS, SSS, and PBCH may be referred to as synchronization signal block (SSB). A cell may include one or more SSBs. Each SSB in a cell may be associated with a beam. SSBs may be configured, activated, or deactivated.

Primary cell 120 may transmit SSBs. However, SCell 125 may be an SSB-less SCell. For example, in reduced capability (RedCap) mode, the SCell 125 may be an SSB-less SCell. By removing SSBs, SSB-less SCells may be less complex and more power-efficient. In another example, SSB-less SCells may be used in scenarios where SSB-based synchronization is not necessary, e.g., in energy-saving mode.

In some embodiments, the SCell 125 is an SSB-less SCell, e.g., SSB-less SCell is not configured with persistent SSB and is aggregated with PCell 120 in an intra-band or inter-band carrier aggregation scenario. SCell 125 may not configured with SSB-based measurement timing configuration (SMTC). PCell 120 has SSB transmissions.

When SSB-less SCell 125 is activated, for the operation of intra-band/inter-band SSB-less carrier aggregation, it is desirable to perform Layer 3 (L3) measurements and automatic gain control (AGC). The UE 104 may perform L3 measurements for making handover decisions, monitoring the quality of service (QOS), or cell selection or reselection. The UE 104 may perform AGC to maintain the output signal amplitude. In some embodiments, the base station 108 may send on-demand SSB on the SSB-less SCell 125 to support these operations.

When SSB-less SCell 125 is deactivated, it is desirable to perform L3 measurement, e.g., for cell selection or cell reselection procedures. In some embodiments, the base station 108 may transmit on-demand SSB on the SSB-less SCell 125 to enable L3 measurements on SSB-less SCell 125.

In some embodiments, the SSB transmission on an SSB may be absent on an SCell for some duration. However, measurement and operations associated with such SSB may be desired on that SCell. An on-demand SSB transmission on such SCell may support L3 measurements and operations.

In some embodiments, the on-demand SSB transmission is a semi-persistent SSB transmission. In some embodiments, the on-demand SSB transmission is an aperiodic SSB transmission. The base station 108 may notify the UE 104 about the semi-persistent or aperiodic SSB transmission. The base station 108 may use downlink (DL) signaling 130 to configure and notify the UE 104 with on-demand SSB transmission on SCell 125. The DL signaling 130 may be transmitted in either PCell 120, SCell 125, or any other configured or activated SCell.

In some embodiments, the DL signaling 130 may be a DCI, a medium access control (MAC) control element (CE), or a radio resource control (RRC) signaling.

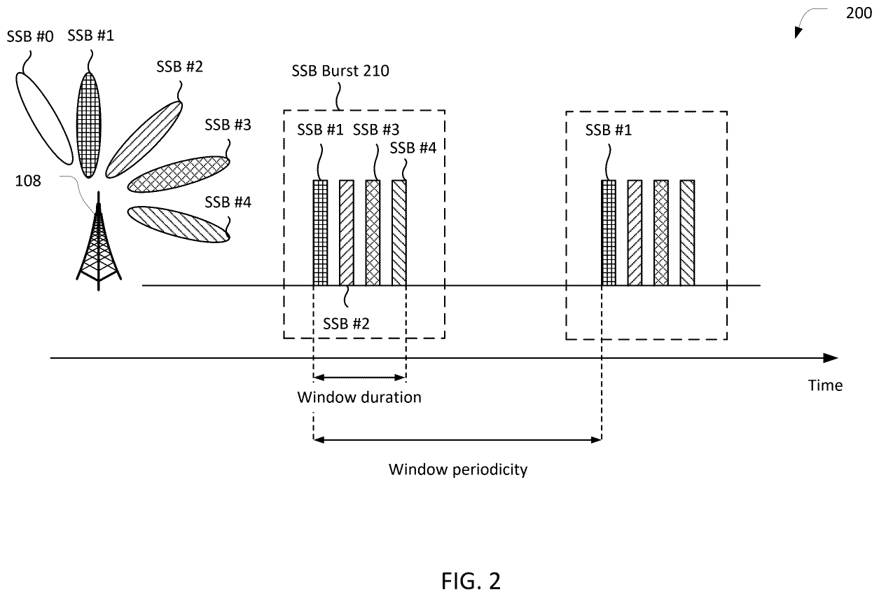

FIG. 2 illustrates a transmission diagram 200 in accordance with some embodiments. The base station 108 may provide one or more beams on the PCell or SCell. Each beam may be associated with an SSB (SSB index), e.g., SSB #0-4. The base station 108 may generate and transmit multiple SSBs at regular intervals to the UE 104.

For example, the base station 108 may configure an SSB burst 210 in which SSB #1, SSB #2, SSB #3, and SSB #4 are transmitted by the base station 108. The 3GP specifications have introduced an SSB-based RRM measurement timing configuration (SMTC) window. The UE 104 may be configured with SMTC window duration and periodicity. In some embodiments, the SSB burst 210 is transmitted during the SMTC window.

In some instances, the duration of the SSB burst 210 may be the same as the duration of the SMTC window. The time between the beginning of the first SSB, e.g., SSB #1, and the last SSB in the SSB burst 210 may be the same as the SMTC window duration. The periodicity of the SSB burst 210 may be the same as the periodicity of the SMTC window. The time between the one instance of transmission of an SSB, e.g., SSB #1, and the next instance of transmission of the same SSB, may be the same as SMTC window periodicity.

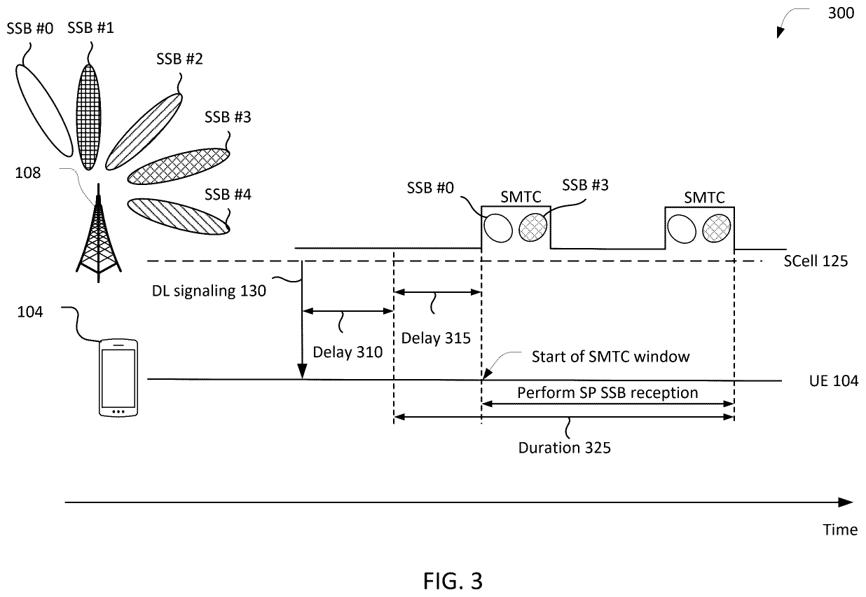

FIG. 3 illustrates a transmission diagram 300 in accordance with some embodiments. The base station 108 may provide one or more beams on the PCell or SCell. Each beam may be associated with an SSB (SSB index), e.g., SSB #0-4. The base station 108 may use DL signaling 130 to configure the UE 104 with on-demand SSB transmission on SCell 125. The on-demand SSB transmission may be a semi-persistent SSB transmission.

In one embodiment, the configuration of SCell 125 may include a parameter indicating that SCell 125 is configured with on-demand SSB. The configuration may be a list of SCell indices and a flag associated with each listed SCell indices. The flag may indicate whether the corresponding SCell is configured with on-demand SSB. For example, a value ‘0’ of the flag may indicate that the corresponding SCell is not configured with on-demand SSB, and a value of ‘1’ may indicate that the corresponding SCell is configured with on-demand SSB. In the example provided in FIG. 3, SSB #0 and SSB #3 are configured for on-demand SSB transmission on SCell 125.

The base station 108 may trigger semi-persistent SSB transmission on SCell 125. Semi-persistent (SP) SSB transmission is similar to periodic SSB transmission but can be dynamically activated or deactivated. For example, base station 108 may use DL signaling 130 to dynamically activate or deactivate the semi-persistent SSB transmission on SCell 125.

In some embodiment, the base station 108 may configure the SMTC window on SCell 125. Upon receiving the DL signal 130 to activate semi-persistent SSB transmission, the UE 104 may calculate the time position of the next SMTC window for detection of SSB transmission. To calculate the next SMTC window, the UE 104 may consider delay 310 associated with the processing of the DL signaling 130. For example, for DL signaling 130 received on slot n, the delay 310 may be k1+3×Nslot, where k1 is the processing delay of DL signaling 130, and Nslot is the number of slots in a subframe. Delay 315 may represent the time that the UE 104 has to wait in addition to delay 310 for the first SMTC window.

In some embodiments, the base station 108 may configure the UE 104 with a duration 325 of semi-persistent SSB transmission. When configured, the duration 325 may start from the beginning of the first SMTC window after reception of the DL signaling 130. In some instances, the duration of 325 may start with the processing delay 310. During the SMTC window, base station 108 may generate and transmit configured SSBs, e.g., SSB #0 and SSB #3.

In some embodiments, base station 108 may explicitly deactivate semi-persistent SSB. In some instances, even when a duration 325 is configured, the base station 108 may explicitly deactivate the semi-persistent SSB.

In some embodiment, the base station 108 may configure semi-persistent SSBs by configuring the SMTC window and a parameter that indicates the number of periodicity or cycles that UE 104 should monitor, receive, or process the transmitted semi-persistent SSBs.

In some embodiments, the DL signaling 130 may be a DCI, a medium access MAC CE, or an RRC signaling. When the DL signaling 130 is an RRC signaling, e.g., a configuration or an information element (IE), it may include a transmission pattern of semi-persistent or aperiodic SSB transmissions. For example, for a semi-persistent SSB, the RRC configuration may include the periodicity of SMTC, transmission duration 325, or SSB transmission number of periodicity. The RRC configuration may include the values for delay 310. For example, the latency of RR processing may be 19 milliseconds (ms).

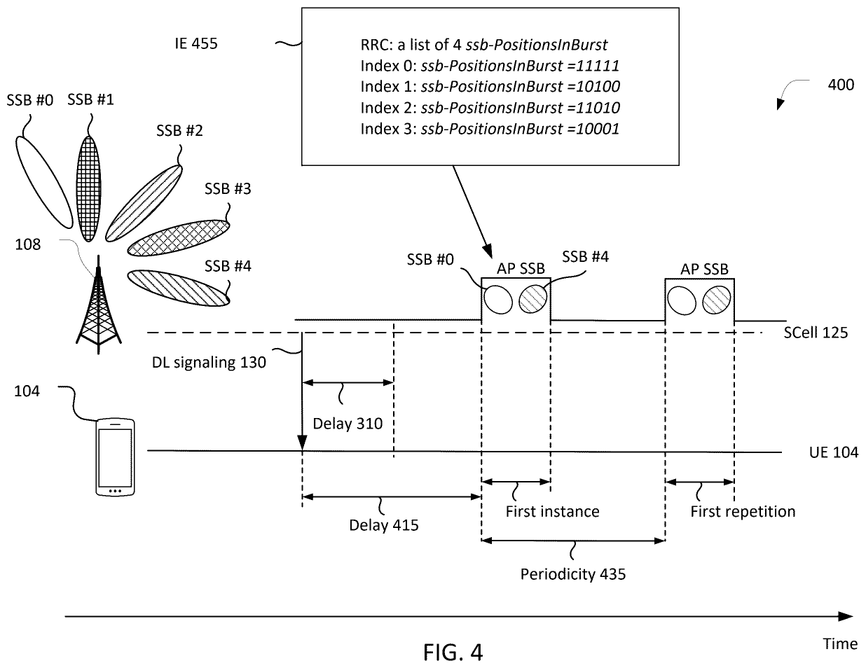

FIG. 4 illustrates a transmission diagram 400 in accordance with some embodiments. The base station 108 may provide one or more beams on the PCell or SCell. Each beam may be associated with an SSB (SSB index), e.g., SSB #0-4. The base station 108 may use DL signaling 130 to configure the UE 104 with on-demand SSB transmission on SCell 125. On-demand SSB transmission may be an aperiodic SSB transmission.

The base station 108 may trigger a periodic SSB transmission on SCell 125. Base station 108 may use DL signaling 130 to dynamically activate or deactivate the aperiodic SSB transmission on SCell 125. The DL signaling 130 may be a command to activate or deactivate the aperiodic SSB. The DL signaling 130, e.g., the activation command, may include a parameter to indicate the number of repetitions. An activated aperiodic SSB may be transmitted (by the base station 108) as many times as indicated by the activation command. In some embodiments, the DL signaling 130, e.g., the activation command, may include periodicity 435 of repetitions.

The UE 104 may consider the delay 310 associated with processing the DL signaling 130 as described above. In some embodiments, the base station 108 may configure the UE 104 with delay 415. The UE 104 may wait for delay 415 before the first aperiodic SSB transmission starts. The aperiodic SSB transmission is automatically terminated or stopped after the configured number of repetitions. In some embodiments, the UE 104 may stop monitoring the aperiodic SSB transmissions after receiving and processing the configured number of repetitions.

In some embodiments, the base station 108 may deactivate the aperiodic SSB transmission. The base station 108 may use the DL signaling 130 to send a deactivation command to deactivate an aperiodic SSB transmission on SCell 125.

In some embodiments, an activation command for an aperiodic SSB transmission may activate an SSB burst transmission, including the transmission of L SSBs, where L is configured by the base station 108 or defined in the 3GPP technical specifications (TSs). For example, L may be defined or configured to be 8, which may imply that one instance of aperiodic SSB includes the transmission of 8 SSBs in one SSB burst.

In some embodiments, the DL signaling 130 may include an SSB burst pattern for one instance of aperiodic SSB transmission. The base station 108 may configure one or more patterns, and the DL signaling 130 may include an index of a pattern of one or more configured patterns. For example, base station 108 may configure the UE 104 with SSB burst patterns using RRC signaling. The base station 108 may configure a list of SSB positions in a burst to identify which configured or activated SSB is included in the SSB burst. For example, the base station may use RRC information element (IE) 455 of the list of ssb-PositionInBurst to configure SSB burst patterns.

For example, the IE 455 may configure 4 different SSB burst configurations. The first configuration associated with Index 0 includes all 5 SSBs, e.g., SSB #0-4. The second configuration associated with Index 1 includes the first SSB, SSB #0, and the third SSB, SSB #2.

The third configuration associated with Index 2 includes the first SSB, SSB #0, the second SSB, SSB #1, and the fourth SSB, SSB #3. The fourth configuration associated with Index 3 includes the first SSB, SSB #0, and the fifth SSB, SSB #4. The DL signaling 130 activating the aperiodic SSB may include Index 3 to indicate the fourth configuration associated with an SSB burst of SSB #0 and SSB #4.

For example, the UE 104 may receive the DL signaling 130 from the base station 108. The DL signaling 130 may be an activation command triggering an aperiodic SSB transmission. The DL signaling 130 may include a field indicating the number of repetitions of the aperiodic SSB. The number of repetitions may be configured to one repetition. The DL signaling 130 may include a field indicating the index of a configuration in the ssb-PositionInBurst. The field may indicate the Index 3 associated with SSB #0 and SSB #4 transmission in the SSB burst. The DL signaling 130 may include the value of delay 415, the UE 104 may be configured by the value of delay 415, or the value of delay 415 may be defined in the 3GPP TSs. The DL signaling 130 may include a field indicating the periodicity 435. After receiving and processing the DL signaling 130, the UE 104 may wait for a time determined by delay 415. After that, the UE 104 may start monitoring the DL transmission on SCell 125 to detect and process aperiodic SSB burst transmission of SSB #0 and SSB #4 on the first instance of aperiodic SSB burst transmission. Based on a time determined by periodicity 435, the UE 104 may monitor, detect, and process the first repetition of the aperiodic SSB burst transmission. The base station 108 may terminate transmission of aperiodic SSB burst on SCell 125 after the completion of the first repetition, or the UE 104 may stop monitoring for aperiodic SSB burst transmission on SCell 125.

The base station 108 may activate or deactivate semi-persistent or aperiodic SSB transmission on SCell 125, where the SCell 125 may be an activated or deactivated SCell. For example, SCell 125 may be a deactivated SCell, and the base station may send the DL signaling 130 to activate semi-persistent or aperiodic SSB transmission on SCell 125. In response to DL signaling 130, the UE 104 may monitor, detect, receive, and process the activated semi-persistent or aperiodic SSB on the SCell 125.

The DL signaling 130 may be a DCI, a MAC CE, or an RRC signaling. When the DL signaling 130 is an RRC signaling, e.g., a configuration or an IE, it may include a transmission pattern of semi-persistent or aperiodic SSB transmissions. For example, for an aperiodic SSB, the RRC configuration may include an SSB burst pattern for one instance of periodic SSB transmission. The RRC configuration may include the values for delay 310 or delay 415. For example, the latency of RR processing may be 19 milliseconds (ms).

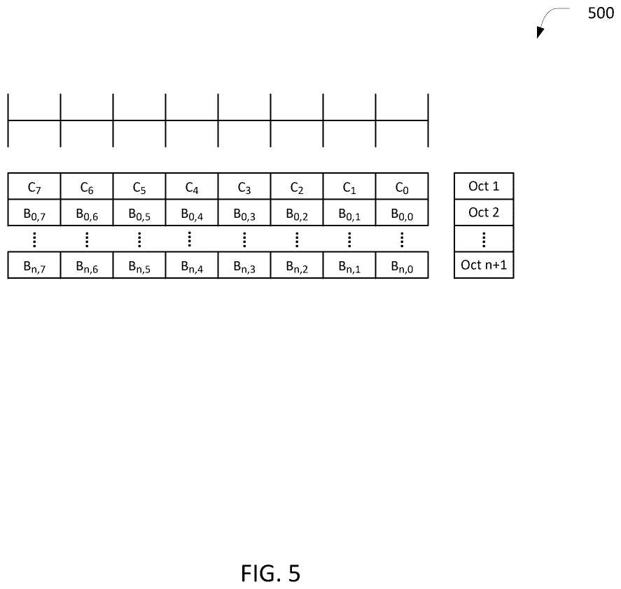

FIG. 5 illustrates a control information 500 in accordance with some embodiments. Control information 500 may be an example of a DL MAC CE.

The first octet 1, including fields C₀-C₇, may be associated with indices of SSB-less (SSBs without a configured persistent SSB) SCells. For example, if Cᵢ has value ‘1’ it may indicate that the base station 108 may transmit on-demand SSB (semi-persistent or aperiodic SSB) in the i^{th} configured SSB-less SCell. If Cᵢ has value ‘0’ it may indicate that the base station 108 may not transmit on-demand SSB (semi-persistent or aperiodic SSB) in the i^{th} configured SSB-less SCell. The UE 104 may monitor on-demand SSB transmission in all indicated SSB-less SCell(s).

The following octets may indicate an SSB transmission pattern. For example, B_{i,0}-B_{i,7} may indicate an 8-bit SSB transmission pattern of one SSB burst for SSB-less SCell with SCell index i. B_{i,0}-B_{i,7} may be configured by the base station 108 or interpreted by the UE 104 only when corresponding SCell transmits on-demand SSB, e.g., Cᵢ=‘1’.

In some embodiments, the control information 500 may be transmitted by the base station 108 on the PCell 120, SCell 125, or any configured, activated, or available SCell.

In some embodiments, upon reception of the control information 500, the UE 108 may generate and transmit a confirmation message to the base station 108. In some instances, the confirmation message may be included in an uplink (UL) MAC CE. The UL MAC CE may be transmitted on the same cell in which the control information 500 was transmitted (by the base station 108) or received (by the UE 104). In some instances, the UL MAC Ce may only include a subheader, e.g., a fixed size of zero bits, as a response to confirm the reception of the control information 500.

In some embodiments, the UL confirmation may be included in a hybrid automatic repeat request (HARQ) acknowledgment (ACK)/negative acknowledgment (NACK) message.

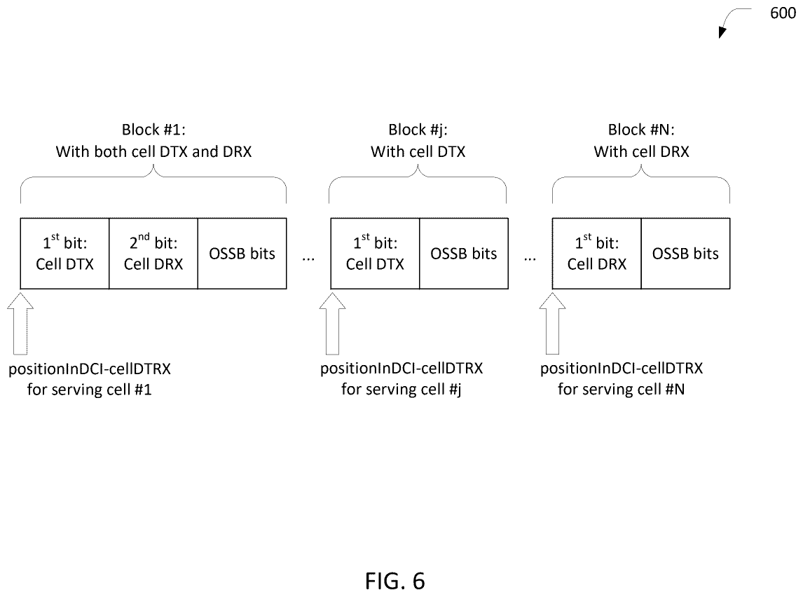

FIG. 6 illustrates a DCI 600 in accordance with some embodiments. The DCI 600 represents a DCI signaling aspect in which on-demand SSB (OSSB) bits are provided within one DCI block with the cell discontinuous transmission (DTX)/discontinuous reception (DRX) indication and one-bit NES conditional handover (CHO) indication. This may be done without having to introduce a new positionInDCI parameter that is dedicated to the OSSB bits.

The DCI 600 may include one or more indications for a plurality of blocks (for example, N blocks). Each block may correspond to a serving cell. For example, the DCI 600 may include indications for block #1, block #j, and block #N. The starting position of each block may be indicated by a parameter positionInDCI-cellDTRX that is provided by higher layers for the UE 104. For example, the base station 108 may transmit, via RRC signaling, a cell group configuration that includes a serving cell configuration for various serving cells, e.g., a PCell, a PSCell, or an SCell. The serving cell configuration may include a positionInDCI-cellDTRX parameter that the UE 104 uses to determine which indications in the DCI correspond to that particular serving cell.

Each block may include a cell DTX/DRX indication and an NES CHO indication. The cell DTX/DRX indication may indicate whether a configured cell DTX/DRX is activated or deactivated. The cell DTX/DRX indication may be two bits if both cell DTX and cell DRX are configured for the corresponding serving cell, with the most significant bit (MSB) corresponding to the cell DTX configuration and the least significant bit (LSB) corresponding to cell DRX configuration. If either cell DTX or cell DRX is configured for a cell but not both, the cell DTX/DRX indication may include one bit.

As shown, serving cell #1 may have both cell DTX and cell DRX configured; thus, its cell DTX/DRX indication includes two bits. Serving cell #j may only include a cell DTX configuration; thus, its cell DTX/DRX indication includes one bit to activate/deactivate the cell DTX configuration. Serving cell #N may only include a cell DRX configuration; thus, its cell DTX/DRX indication includes one bit to activate/deactivate the cell DRX configuration.

The NES CHO indication may be provided by one bit that follows the cell DTX/DRX bit(s). The NES CHO bit may be set to ‘1’ to indicate the corresponding cell is entering NES mode. The NES CHO bit may be set to ‘0’ to indicate the corresponding cell is not entering NES mode. Alternative bit settings may be used.

The OSSB bits may explicitly trigger on-demand SSB (semi-persistent or aperiodic SSB) transmission. The OSSB bits may indicate activation or deactivation of on-demand SSB transmission in the corresponding SCell. The OSSB bits may include one bit to indicate activation or deactivation of on-demand SSB transmission in the corresponding SCell. For example, block #1 is associated with serving cell #1. If the OSSB bits in block #1 include a one-bit activation/deactivation bit with value ‘1’, it may activate on-demand SSB transmission in serving cell #1. A value ‘0’ of the field may deactivate on-demand SSB transmission in serving cell #1.

In some embodiments, the OSSB bits may include an on-demand SSB transmission pattern, as explained above. The on-demand SSB transmission is decoupled with Cell DTX/DRx.

In some embodiments, on-demand SSB transmission may be triggered only in an activated SCell. Alternatively, in other embodiments, the on-demand SSB transmission may be triggered on both activated or deactivated SCells.

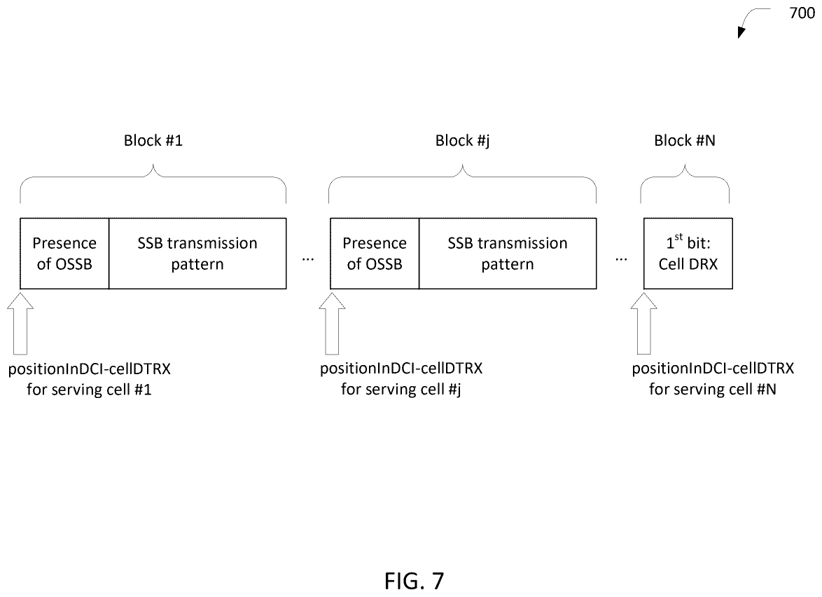

FIG. 7 illustrates another DCI 700 in accordance with some embodiments. The DCI 700 represents a DCI signaling aspect in which a one-bit presence of an OSSB field may be used to activate or deactivate on-demand SSB transmission.

If the presence of the OSSB field in block #1 has value ‘1’, it may activate on-demand SSB transmission in the corresponding SCell associated with block #1, e.g., serving cell #1. If the presence of the OSSB field in block #1 has value ‘0’, it may deactivate on-demand SSB transmission in the corresponding SCell associated with block #1, e.g., serving cell #1.

In some embodiments, if the one-bit presence of the OSSB field in a block has the value ‘1’, the SSB transmission pattern (e.g., ssb-PositionInBurst) can be optionally followed to indicate transmitted SSBs in one SSB burst (e.g., SSB beam directions). For example, in FIG. 7, the presence of an OSSB bit in block #N is not followed by the SSB transmission pattern.

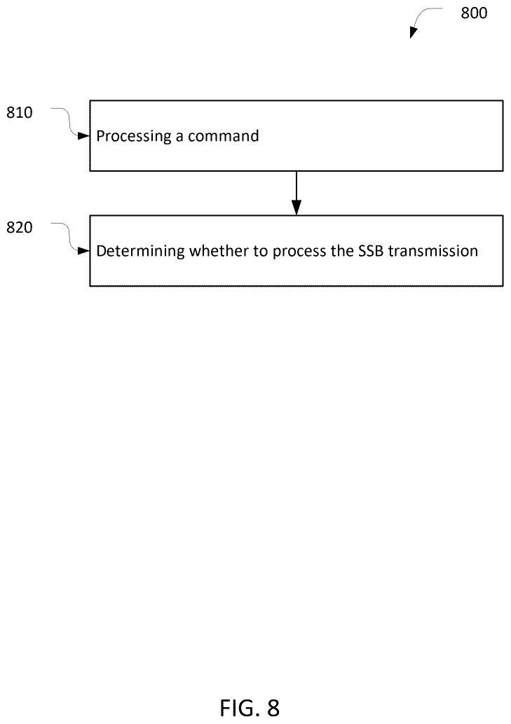

FIG. 8 illustrates an operation flow/algorithmic structure in accordance with some embodiments. The operation flow/algorithmic structure 800 may be performed or implemented by a UE such as, for example, the UE 104 or UE 1000; or components thereof, for example, baseband processor circuitry 1004A.

The operation flow/algorithmic structure 800 may include, at 810, processing a command. The UE 104 may receive and process a command transmitted by the base station 108. The command may be associated with an SSB transmission on an SCell that is not configured with a persistent SSB.

In some embodiments, the command is an activation command. In other embodiments, the command is a deactivation command.

In some embodiments, the SSB transmission is semi-persistent SSB transmission. The UE 104 may receive and process a configuration, including an SMTC configuration. The UE 104 may determine the time position of the next SMTC window based on the configuration of the SMTC. The UE 104 may use processing delay information in calculating the time position of the next SMTC window.

In some embodiments, the SSB transmission is an aperiodic SSB transmission. The UE 104 may receive and process a configuration associated with a time offset or delay between a reception for the command and reception of the aperiodic SSB transmission. The configuration may be an RRC signaling. The configuration may include an SSB burst pattern of one or more SSB burst patterns.

In some embodiments, the command may be a MAC CE. The command may be an activation command and may include an index of the SCell or an SSB transmission pattern associated with the SSB transmission. The UE 104 may determine semi-persistent SSB occasions and monitor the semi-persistent SSB occasions in the SCell. A semi-persistent SSB occasions may be determined by time-frequency resources allocated or scheduled for semi-persistent SSB transmissions.

In some embodiments, the UE 104 may generate and transmit a confirmation to the base station 108. The confirmation may confirm the receipt of the command, e.g., the activation or deactivation command. UE 104 may generate the confirmation in response to receiving and processing the command. The confirmation may be an UL MAC CE or a HARQ ACK/NACK message.

In some embodiments, the command may be a DCI, e.g., a DCI format 2_9 as defined in the 3GPP TSs. The DCI may include a one-bit indication to activate or deactivate the SSB transmission on the SCell. The DCI may include an SSB transmission pattern associated with the SSB transmission. The DCI may be a common DCI or a dedicated DCI.

In some embodiments, the UE 104 may determine that the SCell is deactivated. The UE 104 may not expect to activate an on-demand SSB transmission on the deactivated SCell.

The operation flow/algorithmic structure 800 may include, at 820, determining whether to process the SSB transmission. In some embodiments, the UE 104 may determine that the command is an activation command. Based on determining that the command is an activation command, the UE 104 may determine to monitor and process SSB transmission on the SCell.

In other embodiments, the UE 104 may determine that the command is a deactivation command. Based on determining that the command is a deactivation command, the UE 104 may determine not to monitor or process SSB transmission on the SCell.

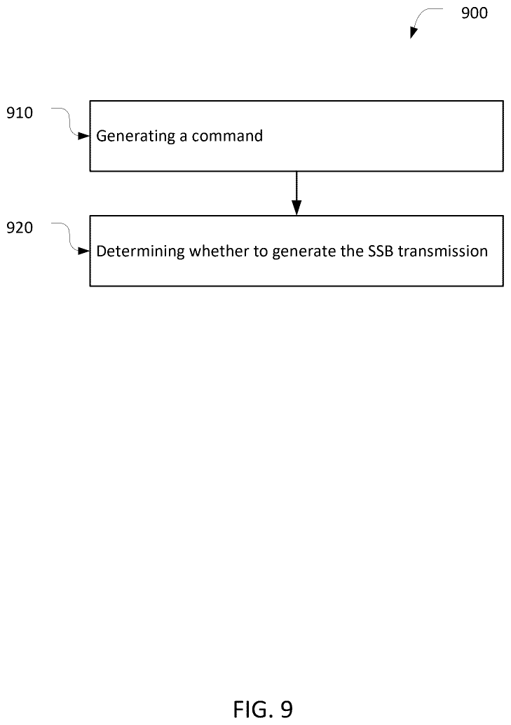

FIG. 9 illustrates an operation flow/algorithmic structure in accordance with some embodiments. The operation flow/algorithmic structure 900 may be performed or implemented by a base station such as, for example, the base station 108 or the base station 1100; or components thereof, for example, baseband processor circuitry 1104A.

The operation flow/algorithmic structure 900 may include, at 910, generating a command. The base station 108 may generate and transmit a command to the UE 104. The command may be associated with an SSB transmission on an SCell that is not configured with a persistent SSB.

In some embodiments, the command is an activation command. In other embodiments, the command is a deactivation command.

In some embodiments, the SSB transmission is semi-persistent SSB transmission. The base station 108 may generate and transmit a configuration, including an SMTC configuration. The configuration may be used to determine the time position of the SMTC window.

In some embodiments, the SSB transmission is an aperiodic SSB transmission. The base station 108 may generate and transmit a configuration associated with a time offset or delay between a reception for the command and a reception of the aperiodic SSB transmission. The configuration may be an RRC signaling. The configuration may include an SSB burst pattern of one or more SSB burst patterns.

In some embodiments, the command may be a MAC CE. The command may be an activation command and may include an index of the SCell or an SSB transmission pattern associated with the SSB transmission.

In some embodiments, the base station 108 may receive and process a confirmation from the UE 104. The confirmation may confirm the receipt of the command, e.g., the activation or deactivation command. The base station 108 may process the confirmation in response to generating and sending the command to the UE 104. The confirmation may be an UL MAC CE or a HARQ ACK/NACK message.

In some embodiments, the command may be a DCI, e.g., a DCI format 2_9 as defined in the 3GPP TSs. The DCI may include a one-bit indication to activate or deactivate the SSB transmission on the SCell. The DCI may include an SSB transmission pattern associated with the SSB transmission. The DCI may be a common DCI or a dedicated DCI.

In some embodiments, the base station 108 may determine that the SCell is deactivated. The base station 108 may not activate an on-demand SSB transmission on the deactivated SCell.

The operation flow/algorithmic structure 800 may include, at 820, determining whether to generate the SSB transmission. In some embodiments, the base station 108 may determine that the command is an activation command. Based on determining that the command is an activation command, the base station 108 may determine to generate and transmit SSB transmission on the SCell.

In other embodiments, the base station 108 may determine that the command is a deactivation command. Based on determining that the command is a deactivation command, base station 108 may determine not to monitor or process SSB transmission on the SCell.

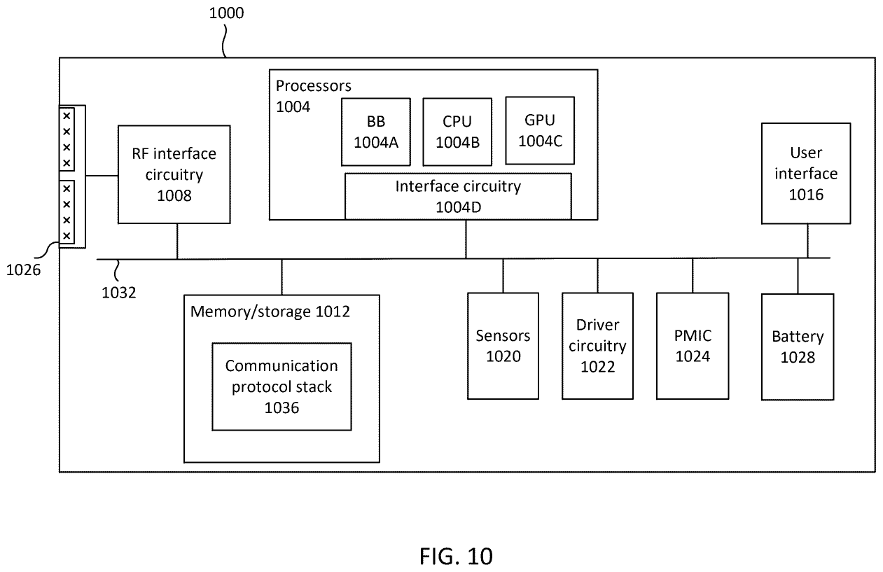

FIG. 10 illustrates a UE 1000 in accordance with some embodiments. The UE 1000 may be similar to and substantially interchangeable with the UE 104.

The UE 1000 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smartwatch), or Internet-of-things devices.

The UE 1000 may include processors 1004, RF interface circuitry 1008, memory/storage 1012, user interface 1016, sensors 1020, driver circuitry 1022, power management integrated circuit (PMIC) 1024, antenna 1026, and battery 1028. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangements of the components shown may occur in other implementations.

The components of the UE 1000 may be coupled with various other components over one or more interconnects 1032, which may represent any type of interface, input/output, bus (local, system, or expansion), transmission line, trace, or optical connection that allows various circuit components (on common or different chips or chipsets) to interact with one another.

The processors 1004 may include processor circuitry such as, for example,

baseband processor circuitry (BB) 1004A, central processor unit circuitry (CPU) 1004B, and graphics processor unit circuitry (GPU) 1004C. The processors 1004 may include any type of circuitry or processor circuitry that executes or otherwise operates computer-executable instructions, such as program code, software modules, or functional processes from memory/storage 1012 to cause the UE 1000 to perform operations as described herein. The processors 1004 may also include interface circuitry 1004D to communicatively couple the processor circuitry with one or more other components of the UE 1000.

In some embodiments, the baseband processor circuitry 1004A may access a communication protocol stack 1036 in the memory/storage 1012 to communicate over a 3GPP-compatible network. In general, the baseband processor circuitry 1004A may access the communication protocol stack 1036 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1008.

The baseband processor circuitry 1004A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1012 may include one or more non-transitory, computer-readable media that includes instructions (for example, communication protocol stack 1036) that may be executed by one or more of the processors 1004 to cause the UE 1000 to perform various operations described herein.

The memory/storage 1012 includes any type of volatile or non-volatile memory that may be distributed throughout the UE 1000. In some embodiments, some of the memory/storage 1012 may be located on the processors 1004 themselves (for example, memory/storage 1012 may be part of a chipset that corresponds to the baseband processor circuitry 1004A), while other memory/storage 1012 is external to the processors 1004 but accessible thereto via a memory interface. The memory/storage 1012 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 1008 may include transceiver circuitry and a radio frequency front module (RFEM) that allows the UE 1000 to communicate with other devices over a radio access network. The RF interface circuitry 1008 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1026 and proceed to filter and amplify (with a low-noise amplifier) the signal. The signal may be provided to a receiver of the transceiver that down-converts the RF signal into a baseband signal that is provided to the baseband processor of the processors 1004.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1026.

In various embodiments, the RF interface circuitry 1008 may be configured to transmit/receive signals in a manner compatible with NR access technologies.

The antenna 1026 may include antenna elements to convert electrical signals into radio waves to travel through the air and to convert received radio waves into electrical signals. The antenna elements may be arranged into one or more antenna panels. The antenna 1026 may have antenna panels that are omnidirectional, directional, or a combination thereof to enable beamforming and multiple input, multiple output communications. The antenna 1026 may include microstrip antennas, printed antennas fabricated on the surface of one or more printed circuit boards, patch antennas, or phased array antennas. The antenna 1026 may have one or more panels designed for specific frequency bands including bands in FR1 or FR2.

The user interface 1016 includes various input/output (I/O) devices designed to enable user interaction with the UE 1000. The user interface 1016 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1000.

The sensors 1020 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1022 may include software and hardware elements that operate to control particular devices that are embedded in the UE 1000, attached to the UE 1000, or otherwise communicatively coupled with the UE 1000. The driver circuitry 1022 may include individual drivers allowing other components to interact with or control various input/output (I/O) devices that may be present within or connected to the UE 1000. For example, driver circuitry 1022 may include a display driver to control and allow access to a display device, a touchscreen driver to control and allow access to a touchscreen interface, sensor drivers to obtain sensor readings of sensors 1020, and control and allow access to sensors 1020, drivers to obtain actuator positions of electro-mechanic components or control and allow access to the electro-mechanic components, a camera driver to control and allow access to an embedded image capture device, audio drivers to control and allow access to one or more audio devices.

The PMIC 1024 may manage power provided to various components of the UE 1000. In particular, with respect to the processors 1004, the PMIC 1024 may control power-source selection, voltage scaling, battery charging, or DC-to-DC conversion.

A battery 1028 may power the UE 1000, although in some examples, the UE 1000 may be mounted deployed in a fixed location and may have a power supply coupled to an electrical grid. The battery 1028 may be a lithium-ion battery, a metal-air battery, such as a zinc-air battery, an aluminum-air battery, a lithium-air battery, and the like. In some implementations, such as in vehicle-based applications, the battery 1028 may be a typical lead-acid automotive battery.

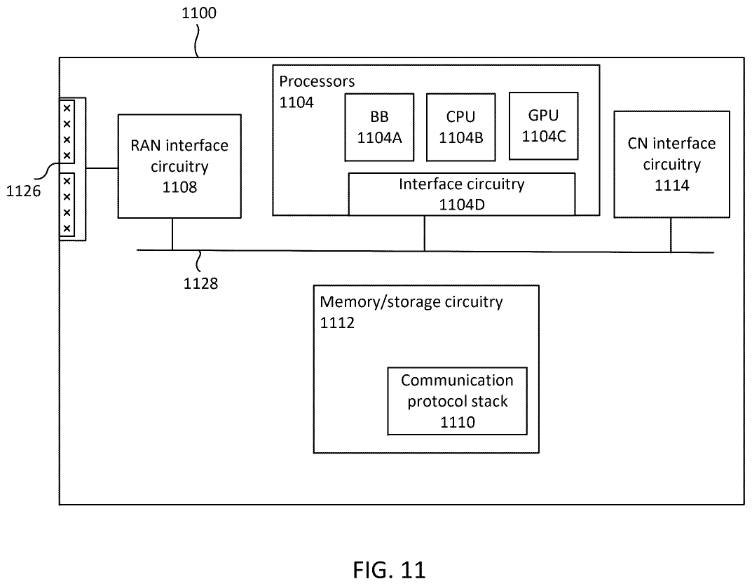

FIG. 11 illustrates a network device 1100 in accordance with some embodiments. The network device 1100 may be similar to and substantially interchangeable with base station 108.

The network device 1100 may include processors 1104, RF interface circuitry 1108 (if implemented as a base station), core network (CN) interface circuitry 1114, memory/storage circuitry 1112, and antenna structure 1126.

The components of the network device 1100 may be coupled with various other components over one or more interconnects 1128.

The processors 1104, RF interface circuitry 1108, memory/storage circuitry 1112 (including communication protocol stack 1110), antenna structure 1126, and interconnects 1128 may be similar to like-named elements shown and described with respect to FIG. 10.

The processors 1104 may include processor circuitry such as, for example, baseband processor circuitry (BB) 1104A, central processor unit circuitry (CPU) 1104B, and graphics processor unit circuitry (GPU) 1104C. The processors 1104 may include any type of circuitry or processor circuitry that executes or otherwise operates computer-executable instructions, such as program code, software modules, or functional processes from memory/storage circuitry 1112 to cause the UE 1000 to perform operations as described herein. The processors 1104 may also include interface circuitry 1104D to communicatively couple the processor circuitry with one or more other components of the network device 1100.

The CN interface circuitry 1114 may provide connectivity to a core network, for example, a 5th Generation Core network (5GC) using a 5GC-compatible network interface protocol such as carrier Ethernet protocols or some other suitable protocol. Network connectivity may be provided to/from the network device 1100 via a fiber optic or wireless backhaul. The CN interface circuitry 1114 may include one or more dedicated processors or FPGAs to communicate using one or more of the aforementioned protocols. In some implementations, the CN interface circuitry 1114 may include multiple controllers to provide connectivity to other networks using the same or different protocols.

It is well understood that the use of personally identifiable information should follow privacy policies and practices generally recognized as meeting or exceeding industry or governmental requirements for maintaining users' privacy. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry described above in connection with one or more of the preceding figures may be configured to operate according to one or more of the examples set forth below. For another example, circuitry associated with a UE, base station, or network element described above in connection with one or more of the preceding figures may be configured to operate according to one or more of the examples set forth below in the example section.

### EXAMPLES

In the following sections, further exemplary embodiments are provided.

Example 1 includes a method including: processing a command associated with a synchronization signal block (SSB) transmission on a secondary cell (SCell) that is not configured with a persistent SSB; and determining, based on the command, whether to process the SSB transmission on the SCell.

Example 2 includes the method of example 1 or some other examples herein, wherein the command is an activation command and said determining whether to process the SSB transmission on the SCell comprises: determining to process the SSB transmission on the SCell.

Example 3 includes the method of examples 1 or 2 or some other example herein, wherein the command is a deactivation command and said determining whether to process the SSB transmission on the SCell includes: determining not to process the SSB transmission on the SCell.

Example 4 includes the method of any of examples 1-3 or some other example herein, wherein the SSB transmission is a semi-persistent SSB transmission, and the method further includes: processing a configuration including a synchronization signal block (SSB)-based measurement timing configuration (SMTC) configuration associated with the SCell; and determining, based on the SMTC configuration, a time position of an SMTC window for detecting the SSB transmission.

Example 5 includes the method of any of examples 1-4 or some other example herein, wherein said determining the time position of the SMTC window is based further on an activation delay time.

Example 6 includes the method of any of examples 1-5 or some other example herein, wherein the SSB transmission is an aperiodic SSB transmission, and the method further includes: processing a radio resource control configuration including a timing offset between a reception of the command and a reception of the SSB transmission.

Example 7 includes the method of any of examples 1-6 or some other example herein, wherein the SSB transmission is an aperiodic SSB transmission, and the command indicates an SSB burst pattern of one or more SSB burst patterns.

Example 8 includes the method of any of examples 1-7 or some other example herein, further including: processing a radio resource control (RRC) configuration including the one or more SSB burst patterns.

Example 9 includes the method of any of examples 1-8 or some other example herein, wherein the command is a downlink control information (DCI), a medium access control (MAC) control element (CE), or a radio resource control (RRC) message.

Example 10 includes the method of any of examples 1-9 or some other example herein, wherein the command is a MAC CE and the MAC CE includes: an index of the SCell; or a SSB transmission pattern associated with the SSB transmission.

Example 11 includes the method of any of examples 1-10 or some other example herein, further including: determining, based on the MAC CE, semi-persistent SSB occasions; and monitoring the semi-persistent SSB occasions in the SCell.

Example 12 includes the method of any of examples 1-11 or some other example herein, further including: generating a confirmation to be transmitted to a base station, the confirmation to confirm receipt of the command.

Example 13 includes the method of any of examples 1-12 or some other example herein, wherein the confirmation is an uplink (UL) MAC CE or is a hybrid automatic repeat request (HARQ) acknowledgment (ACK) message.

Example 14 includes the method of any of examples 1-13 or some other example herein, wherein the command is a DCI, and the DCI includes a SSB transmission pattern associated with the SSB transmission.

Example 15 includes the method of any of examples 1-14 or some other example herein, wherein the command is a DCI, and the DCI includes one bit to activate or deactivate the SSB transmission on the SCell.

Example 16 includes the method of any of examples 1-15 or some other example herein, wherein the command is a DCI, and the method further includes: determining that the

SCell is deactivated; and not expecting to activate the SSB transmission based on said determining that the SCell is deactivated.

Example 17 includes the method of any of examples 1-16 or some other example herein, wherein the command is a DCI, and the DCI is a common DCI or a dedicated DCI.

Example 18 includes the method of any of examples 1-17 or some other example herein, wherein the command is an RRC message, and the RRC message includes a transmission pattern, a periodicity of SMTC, a transmission duration, or a number of SSB transmissions.

Example 19 includes a method including: generating a command associated with a synchronization signal block (SSB) transmission on a secondary cell (SCell) that is not configured with a persistent SSB; and determining, based on the command, whether to generate the SSB transmission on the SCell.

Example 20 includes the method of example 19 or some other example herein, wherein the command is an activation command and said determining whether to generate the SSB transmission on the SCell includes: determining to generate the SSB transmission on the SCell.

Example 21 includes the method of of examples 19 and 20 or some other example herein, wherein the command is a deactivation command and said determining whether to generate the SSB transmission on the SCell includes: determining not to generate the SSB transmission on the SCell.

Example 22 includes the method of any of examples 19-21 or some other example herein, wherein the SSB transmission is a semi-persistent SSB transmission, and the method further includes: generating a configuration including a synchronization signal block (SSB)-based measurement timing configuration (SMTC) associated with the SCell.

Example 23 includes the method of any of examples 19-22 or some other example herein, wherein the SSB transmission is an aperiodic SSB transmission, and the method further includes: generating a radio resource control configuration including a timing offset between a reception of the command and a reception of the SSB transmission.

Example 24 includes the method of any of examples 19-23 or some other example herein, wherein the SSB transmission is an aperiodic SSB transmission, and the command indicates an SSB burst pattern of one or more SSB burst patterns.

Example 25 includes the method of any of examples 19-24 or some other example herein, further includes: generating a radio resource control (RRC) configuration including the one or more SSB burst patterns.

Example 26 includes the method of any of examples 19-25 or some other example herein, wherein the command is a downlink control information (DCI), a medium access control (MAC) control element (CE), or a radio resource control (RRC) message.

Example 27 includes the method of any of examples 19-26 or some other example herein, wherein the command is a MAC CE and the MAC CE includes: an index of the SCell; or a SSB transmission pattern associated with the SSB transmission.

Example 28 includes the method of any of examples 19-27 or some other example herein, further including: processing a confirmation received from a user equipment (UE), the confirmation to confirm receipt of the command.

Example 29 includes the method of any of examples 19-28 or some other example herein, wherein the confirmation is an uplink (UL) MAC CE or is a hybrid automatic repeat request (HARQ) acknowledgment (ACK) message.

Example 30 includes the method of any of examples 19-29 or some other example herein, wherein the command is a DCI, and the DCI includes a SSB transmission pattern associated with the SSB transmission.

Example 31 includes the method of any of examples 19-30 or some other example herein, wherein the command is a DCI, and the DCI includes one bit to activate or deactivate the SSB transmission on the SCell.

Example 32 includes the method of any of examples 19-31 or some other example herein, wherein the command is a DCI, and the DCI is a common DCI or a dedicated DCI.

Example 33 includes the method of any of examples 19-32 or some other example herein, wherein the command is an RRC message, and the RRC message includes a transmission pattern, a periodicity of SMTC, a transmission duration, or a number of SSB transmissions.

Another example may include an apparatus comprising means to perform one or more elements of a method described in or related to any of examples 1-33, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-33, or any other method or process described herein.

Another example may include an apparatus comprising logic, modules, or circuitry to perform one or more elements of a method described in or related to any of examples 1-33, or any other method or process described herein.

Another example may include a method, technique, or process as described in or related to any of examples 1-33, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-33, or portions thereof.

Another example may include a signal as described in or related to any of examples 1-33, or portions or parts thereof.

Another example may include a datagram, information element, packet, frame, segment, PDU, or message as described in or related to any of examples 1-33, or portions or parts thereof, or otherwise described in the present disclosure.

Another example may include a signal encoded with data as described in or related to any of examples 1-33, or portions or parts thereof, or otherwise described in the present disclosure.

Another example may include a signal encoded with a datagram, IE, packet, frame, segment, PDU, or message as described in or related to any of examples 1-33, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-33, or portions thereof.

Another example may include a computer program comprising instructions, wherein execution of the program by a processing element is to cause the processing element to carry out the method, techniques, or process as described in or related to any of examples 1-33, or portions thereof.

Another example may include a signal in a wireless network as shown and described herein.

Another example may include a method of communicating in a wireless network, as shown and described herein.

Another example may include a system for providing wireless communication, as shown and described herein.

Another example may include a device for providing wireless communication, as shown and described herein.

Unless explicitly stated otherwise, any of the above-described examples may be combined with any other example (or combination of examples). The foregoing description of one or more implementations provides illustration and description but is not intended to be exhaustive or to limit the scope of embodiments to the precise form disclosed. Modifications and variations are possible in light of the above teachings or may be acquired from the practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
processing a command associated with a synchronization signal block (SSB) transmission on a secondary cell (SCell) that is not configured with a persistent SSB; and
determining, based on the command, whether to process the SSB transmission on the SCell.

2. The method of claim 1, wherein the command is an activation command, said determining whether to process the SSB transmission on the SCell includes determining to process the SSB transmission on the SCell, and the method further comprises:
processing the SSB transmission.

3. The method of claim 1, wherein the command is a deactivation command, said determining whether to process the SSB transmission on the SCell includes determining not to process the SSB transmission on the SCell; and the method further comprises:
discarding the SSB transmission.

4. The method of claim 1, wherein the SSB transmission is a semi-persistent SSB transmission, and the method further comprises:
processing a configuration including a synchronization signal block (SSB)-based measurement timing configuration (SMTC) configuration associated with the SCell; and
determining, based on the SMTC configuration, a time position of an SMTC window for detecting the SSB transmission.

5. The method of claim 4, wherein said determining the time position of the SMTC window is based further on an activation delay time.

6. The method of claim 1, wherein the SSB transmission is an aperiodic SSB transmission, and the method further comprises:
processing a radio resource control configuration including a timing offset between a reception of the command and a reception of the SSB transmission.

7. The method of claim 1, wherein the SSB transmission is an aperiodic SSB transmission, the command indicates an SSB burst pattern of one or more SSB burst patterns, and the method further comprises:
processing a radio resource control (RRC) configuration including the one or more SSB burst patterns.

8. The method of claim 1, wherein the command is a MAC CE that includes an index of the SCell, or a SSB transmission pattern associated with the SSB transmission, and the method further comprises:
determining, based on the MAC CE, semi-persistent SSB occasions; and
monitoring the semi-persistent SSB occasions in the SCell.

9. The method of claim 1, further comprising:
generating a confirmation to be transmitted to a base station, the confirmation to confirm receipt of the command, wherein the confirmation is an uplink (UL) MAC CE or is a hybrid automatic repeat request (HARQ) acknowledgment (ACK) message.

10. The method of claim 1, wherein the command is a DCI that includes a SSB transmission pattern associated with the SSB transmission or one bit to activate or deactivate the SSB transmission on the SCell, and the method further comprises:
determining that the SCell is deactivated; and
not expecting to activate the SSB transmission based on said determining that the SCell is deactivated.

11. The method of claim 1, wherein the command is an RRC message that includes a transmission pattern, a periodicity of SMTC, a transmission duration, or a number of SSB transmissions.

12. An apparatus comprising:
processing circuitry to:
process a command associated with a synchronization signal block (SSB) transmission on a secondary cell (SCell) that is not configured with a persistent SSB; and
process or discard the SSB transmission based on the command; and
interface circuitry coupled with the processing circuitry to allow communication.

13. The apparatus of claim 12, wherein:
the command is an activation command and the processing circuitry is to process the SSB transmission on the SCell; or
the command is a deactivation command and the processing circuitry is to discard the SSB transmission on the SCell.

14. A method comprising:
generating a command associated with a secondary cell (SCell) that is not configured with a persistent synchronization signal block (SSB), wherein the command is to indicate whether an SSB is to be transmitted on the SCell; and
outputting the command for transmission to a user equipment.

15. The method of claim 14, wherein:
the command is an activation command indicating that the SSB is to be transmitted on the SCell; or
the command is a deactivation command indicating that the SSB is not to be transmitted on the SCell.

16. The method of claim 14, wherein:
the SSB is a semi-persistent SSB, and the method further comprises generating a configuration including a SSB-based measurement timing configuration (SMTC) associated with the SCell;
the SSB is an aperiodic SSB, and the method further comprises generating a radio resource control configuration (RRC) including a timing offset between a reception of the command and a reception of the SSB; or
the SSB is an aperiodic SSB, and the command indicates an SSB burst pattern of one or more SSB burst patterns and the method further comprises generating a radio resource control (RRC) configuration including the one or more SSB burst patterns.

17. The method of claim 14, wherein the command is a MAC CE and the MAC CE includes:
an index of the SCell; or
a SSB transmission pattern associated with the SSB.

18. The method of claim 14, further comprising:
processing a confirmation received from the UE, the confirmation to confirm receipt of the command, wherein the confirmation is an uplink (UL) MAC CE or is a hybrid automatic repeat request (HARQ) acknowledgment (ACK) message.

19. The method of claim 14, wherein the command is a DCI, and the DCI includes:
a SSB transmission pattern associated with the SSB transmission; or
one bit to activate or deactivate the SSB to be transmitted on the SCell.

20. The method of claim 14, wherein the command is a radio resource control (RRC) message that includes a transmission pattern, a periodicity of SMTC, a transmission duration, or a number of SSB transmissions.
